(19) United States
(12) Patent Application Publication
(10) Pub. No.: US 2006/0160627 A1
(43) Pub. Date: Jul. 20, 2006

(54) Typing game apparatus and gaming system

(75) Inventor: Kenichi Fujimori, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/324,340

(22) Filed: Jan. 4, 2006

(30) Foreign Application Priority Data
Jan. 14, 2005 (JP) 2005-007953

(51) Int. Cl. A63F 13/00

(52) U.S. Cl. 463/43

(57) ABSTRACT

The expiration of a validity period of song data for each of a plurality of songs is determined by comparing validity period data of the song data, which are stored in a song data storage area 20a for storing the song data including the validity period data, with the current time and date shown on a timer 30, and expired song data are deleted. Further, song data which do not exist in the song data storage area 20a are identified by comparing the storage content of the song data storage area 20a with a data list transmitted from a server 80, and a request is placed with the server 80 for distribution of these song data.

### RELATED APPLICATIONS

This application claims the priority of Japanese Patent Application No. 2005-007953 filed on Jan. 14, 2005, which is incorporated herein by reference.

### BACKGROUND OF THE INVENTION

1. Field of the Invention

The present invention relates to a typing game apparatus and gaming system, and more particularly to the data management of data having a prescribed validity period.

2. Description of the Prior Art

Currently, with the advancement of communication networks, it is possible to transfer large volumes of data. Accordingly, data distribution systems such as on-demand distribution systems for providing a client with music data or image data such as movies transmitted over a communication network from a server are under development.

An example of this type of data distribution system is the data distribution system described in Japanese Unexamined Patent Publication No. 2004-134880.

Further, with the advancement of electronic information technology, various types of games have been developed, and a large number of games utilizing communication networks are also under development.

In games which utilize communication networks, game data are often distributed over the communication network in a similar fashion to the aforementioned music data and image data.

For example, in a multiplayer network role-playing game performed on a personal computer or the like, game data are distributed from a server via the communication network in order to expand the playing area of the player or add new items.

Meanwhile, a validity period may be applied to the data and programs that are distributed over a communication network in this manner according to a creator of the data and programs.

For example, in the case of music data or the like, a validity period may be set in accordance with the wishes of the artist, the terms of the contract between the artist and the recording label to which the artist belongs, and so on, and likewise in the case of game data, a validity period may be applied to the game data in accordance with the wishes of the creator, in order to increase the premium of the game data.

In such cases, it becomes necessary to perform rigorous management of the validity period of the distributed data in order to comply with the terms of the contract between the artist and recording label or to maintain the premium of the data.

However, when game data having this type of validity period are distributed to a gaming machine such as a typing game apparatus (in other words, an arcade gaming machine) using the distribution method described in Japanese Unexamined Patent Publication No. 2004-134880, and when management is performed on the server side, the supply of server side game data having an expired validity period can be halted simply by deleting the game data, but no measures can be taken in relation to game data that are already distributed.

Further, when validity periods are managed on the gaming machine side, a clerk at the arcade in which the arcade gaming machine is disposed must perform a manual operation on each gaming machine to delete expired data, thereby increasing the data management load on the arcade side.

Moreover, it is difficult for the game data distribution side to confirm that the expired data have been deleted from the corresponding gaming machines. Hence, it is impossible to perform rigorous management of the validity periods of the game data.

Meanwhile, when validity period management is performed by having the arcade gaming machine access the server so that the validity period of the game data can be checked, the time at which the arcade gaming machine accesses the server becomes problematic.

For example, if the arcade gaming machine accesses the server during the business hours of the arcade in which the arcade gaming machine is disposed, customers wishing to play games are present in the arcade, and hence the gaming machine may access the server while a game is being played. In this case, the gaming machine performs two operations, namely accessing the server and executing the game, simultaneously, which may lead to instability in the operations relating to execution of the game. If measures are taken to ensure that games cannot be executed during server access, the playing time of the customer is restricted, which leads to customer dissatisfaction.

On the other hand, when the arcade gaming machine accesses the server outside of business hours (before or after business hours, for example), server access becomes concentrated within a certain fixed time period due to the fact that the opening time and closing time of arcades are typically concentrated within a certain time period (an opening time of 10 am, for example). As a result, an excessive load is placed on the server, leading to situations in which the gaming machine cannot access the server. In this case, management of the game data validity periods, which is performed through access to the server, cannot be performed on all gaming machines, and hence validity period management cannot be performed rigorously.

### SUMMARY OF THE INVENTION

In consideration of the problems described above, the present invention relates to a typing game apparatus and gaming system, and it is a particular object thereof to provide a typing game apparatus and gaming system with which data management of data having a validity period can be executed easily and reliably.

A first feature of the present invention, which is devised in order to solve the problems described above, is a typing game apparatus (for example, a typing game apparatus 1) comprising: display means (for example, a first liquid crystal display 4 and a second liquid crystal display 5) for displaying a character string to be inputted during a typing game and images; input means (for example, a keyboard 3) for inputting the character string; sound producing means (for example, speakers 7) for producing music data; time measuring means (for example, a timer 30) for measuring time; storage means (for example, an HDD 20) for storing game data comprising image data including the aforementioned character string, the aforementioned music data, and validity period data indicating a validity period of the image data and music data; determination means (for example, a CPU 10) for determining the expiration of the validity period of the game data on the basis of the validity period data and the time measuring means; and data management means (for example, the CPU 10) for deleting the game data from the storage means when the validity period of the game data has expired.

A second feature of the present invention is the typing game apparatus comprising the first feature, wherein the typing game apparatus (for example, the typing game apparatus 1) further comprises communication means (for example, game communication means 25) for receiving data from a server (for example, a sever 80) comprising server storage means (for example, a server storage area 85) storing a plurality of the game data and management data creation means (for example, a server CPU 81) for creating management data for the game data existing in the server storage means, wherein the determination means (for example, the CPU 10) determine the presence of non-obtained game data which do not exist in the storage means by comparing the management data received by the communication means (for example, the game communication means 25) with the storage content of the storage means (for example, the HDD 20), and wherein the data management means (for example, the CPU 10) place a request with the server for the non-obtained game data, and store the non-obtained game data in the storage means.

A third feature of the present invention is the typing game apparatus comprising the first feature, wherein the music data are created by music playing data recorded with a music playing performed by musical instruments and voice data which are sung in synchronization with the music playing, and the image data are data recorded with images corresponding to the music data, and include lyrics data corresponding to the music data.

A fourth feature of the present invention is the typing game apparatus (for example, the typing game apparatus 1) comprising the first feature, wherein the time measuring means (for example, the timer 30) are a clock having a function for automatically correcting time errors.

A fifth feature of the present invention is the typing game apparatus (for example, the typing game apparatus 1) comprising the first feature, wherein the determination means (for example, the CPU 10) determine the expiration of the validity period of the game data when power is supplied to the typing game apparatus.

A sixth feature of the present invention is the typing game apparatus (for example, the typing game apparatus 1) comprising the first feature, wherein the input means are a keyboard, and LED means (for example, an LED 302) are disposed in the interior of each key of the keyboard for illuminating the key in a first color when an input operation performed on the key is correct, and illuminating the key in a second color when the input operation performed on the key is incorrect.

A seventh feature of the present invention is the typing game apparatus comprising the first feature, wherein the display means are constituted by a first display unit (for example, the first liquid crystal display 4) for displaying the character string to be inputted during the typing game, and a second display unit (for example, the second liquid crystal display unit 5) for displaying the aforementioned images.

An eighth feature of the present invention is a typing game apparatus (for example, the typing game apparatus 1) comprising: display means for displaying a character string to be inputted during a typing game and images; input means for inputting the character string; sound producing means for producing music data; time measuring means for measuring time; storage means for storing game data comprising image data including the aforementioned character string, the aforementioned music data, and validity period data indicating a validity period of the image data and music data; determination means for determining whether or not a time period up to the expiration of the validity period of the game data is within a reference time period on the basis of the validity period data and the time measuring means; and notification means for providing notification that game data determined by the determination means (for example, the CPU 10) to be within the reference time period are within the reference time period.

A ninth feature of the present invention is a gaming system using the typing game apparatus (for example, the typing game apparatus 1) comprising the first feature, the gaming system comprising: the aforementioned typing game apparatus (for example, the typing game apparatus 1); and a server (for example, the server 80) having: server storage means (for example, the server storage area 85) for storing a plurality of the game data comprising image data including the character string, the music data, and the validity period data indicating the validity period of the image data and music data; server management data creation means (for example, the server CPU 81) for creating management data for the game data existing in the server storage means; and server communication means (for example, server communication means 83) for bidirectional communication with the aforementioned communication means.

A tenth feature of the present invention is the gaming system comprising the ninth feature, wherein the server (for example, the server 80) further comprises server time measuring means (for example, a server timer 86) utilized during the creation of a data list of the game data that can be distributed to the typing game apparatus (for example, the typing game apparatus 1) from the server (for example, the server 80).

An eleventh feature of the present invention is the gaming system comprising the tenth feature, wherein the server time measuring means (for example, the server timer 86) are a clock having a function for automatically correcting time errors.

A twelfth feature of the present invention is a gaming system using the typing game apparatus (for example, the typing game apparatus 1) comprising the eighth feature, the gaming system comprising: the aforementioned typing game apparatus (for example, the typing game apparatus 1); and a server (for example, the server 80) having: server storage means (for example, the server storage area 85) for storing a plurality of the game data comprising image data including the character string, the music data, and the validity period data indicating the validity period of the image data and music data; server management data creation means (for example, the server CPU 81) for creating management data for the game data existing in the server storage means; and server communication means (for example, the server communication means 83) for bi-directional communication with the aforementioned communication means.

### BRIEF DESCRIPTION OF THE DRAWINGS

FIG. 1 is an illustrative view of a gaming system according to an embodiment;

FIG. 2 is a perspective view showing the external form of a typing game apparatus provided in the gaming system according to the embodiment;

FIG. 3 is an illustrative sectional view of a key arranged on a keyboard of the typing game apparatus according to the embodiment;

FIG. 4 is a block diagram showing a control system of the typing game apparatus according to the embodiment;

FIG. 5 is a block diagram showing a control system of a server according to the embodiment;

FIG. 6 is an illustrative view of song data stored in the typing game apparatus and server according to the embodiment;

FIG. 7 is a flowchart of a main control program of the typing game apparatus according to the embodiment;

FIG. 8 is a flowchart of a validity period management processing program of the typing game apparatus according to the embodiment;

FIGS. 9A to 9C are illustrative views of the validity period management processing performed by the typing game apparatus according to the embodiment;

FIG. 10 is a flowchart of a data updating processing program according to the embodiment;

FIG. 11 is an illustrative view of the data updating processing according to the embodiment;

FIG. 12 is a flowchart of a typing game processing program of the typing game apparatus according to the embodiment;

FIG. 13 is a flowchart of a typing game execution processing program of the typing game apparatus according to the embodiment;

FIGS. 14A and 14B are display examples (1) of respective liquid crystal displays during execution of the typing game according to the embodiment; and

FIGS. 15A and 15B are display examples (2) of the respective liquid crystal displays during execution of the typing game according to the embodiment.

### DESCRIPTION OF THE PREFERRED EMBODIMENT

A specific embodiment of a typing game apparatus and a gaming system using this typing game apparatus according to the present invention will now be described in detail with reference to the drawings.

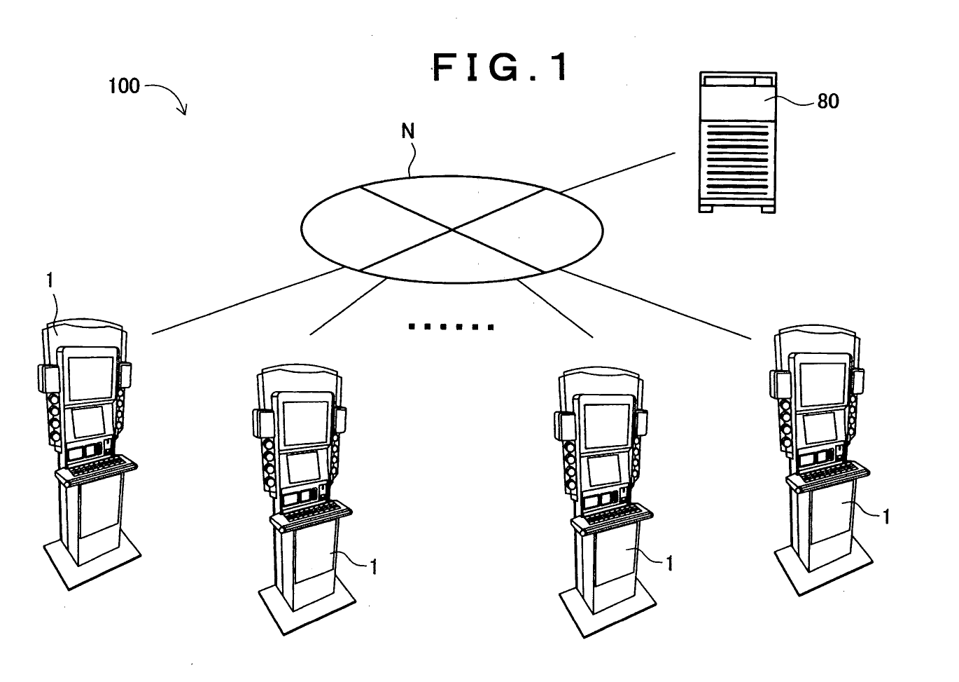

First, the constitution of the gaming system according to the embodiment will be described with reference to the drawings. FIG. 1 is an illustrative view showing a constitutional example of the gaming system according to the embodiment.

A gaming system 100 according to the present invention is constituted by a large number of typing game apparatuses 1 and a server 80. The typing game apparatuses 1 are connected to the server 80 via a network N to function as the gaming system 100 according to this embodiment.

Here, each typing game apparatus 1 is provided with game communication means 25 to be described below, enabling wireless, bi-directional communication with the server 80 via the network N. Further, identification information for each typing game apparatus 1 is associated with each typing game apparatus 1. Hence, during access to the server 80, the server 80 is able to determine the typing game apparatus 1 from which the access originates. Meanwhile, the server 80 is provided with server communication means 83 to be described below, enabling wireless data transmission and reception to and from each typing game apparatus 1 via the network N.

Note that in the gaming system 100 according to this embodiment, connection of the typing game apparatus 1 and server 80 to the network N and data transmission/reception are performed wirelessly, but the present invention is not limited thereto, and connection to the network N may be performed over a wire.

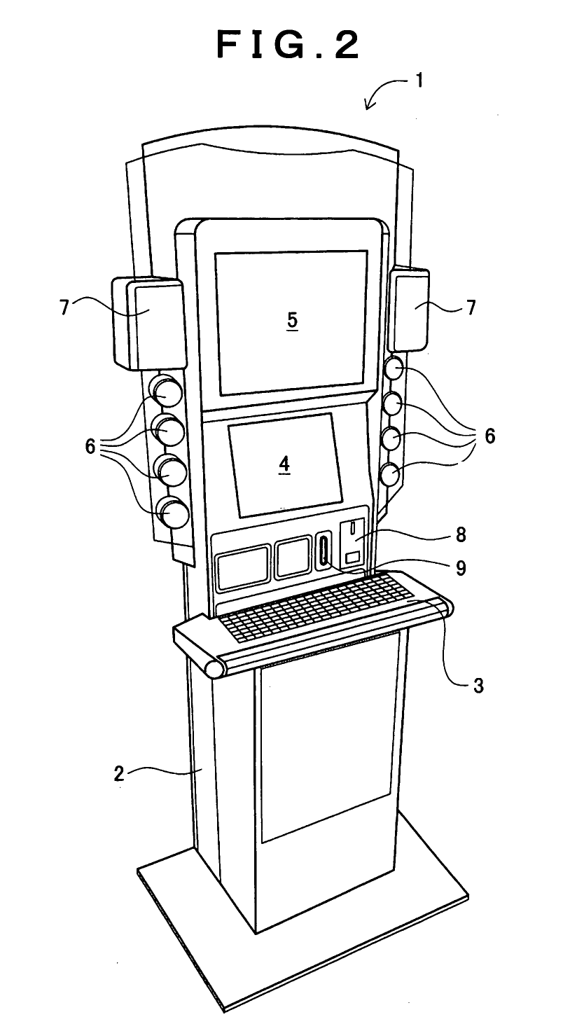

The typing game apparatus 1 according to this embodiment will now be described in detail with reference to FIGS. 2 to 4.

First, the schematic constitution of the typing game apparatus 1 will be described in detail with reference to FIG. 2. FIG. 2 is a perspective view of the external form of the typing game apparatus 1.

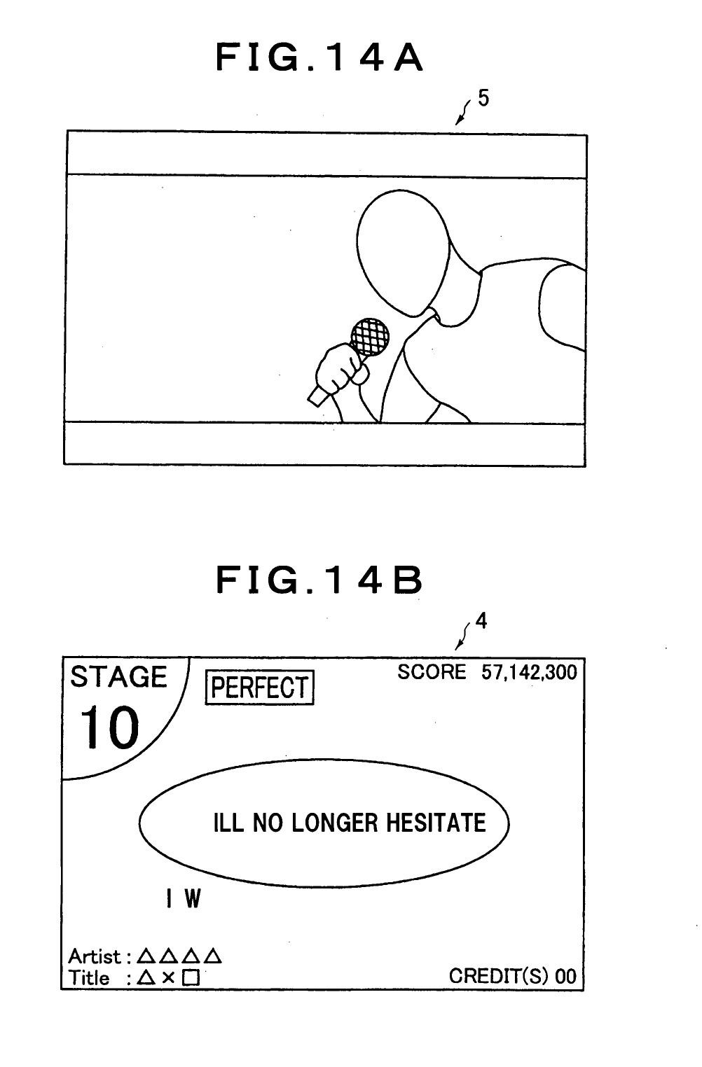

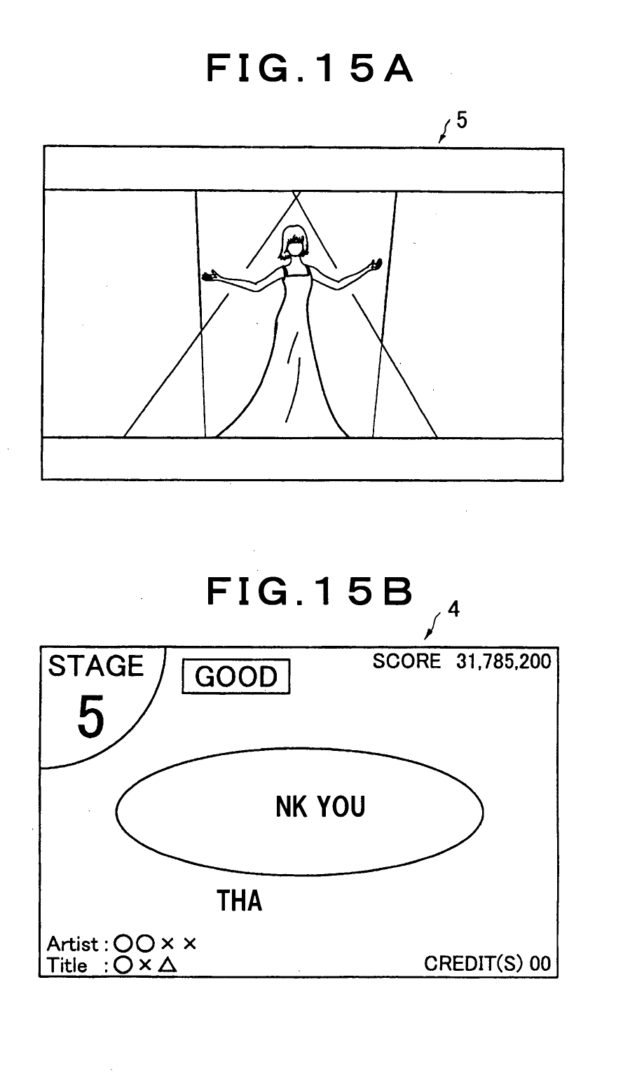

In the typing game apparatus 1 according to this embodiment, a typing game is performed by inputting the lyrics to songs. When the typing game begins, musical accompaniment data relating to the musical accompaniment of a song and voice data relating to the voice of the artist who sings the song are reproduced. As the musical accompaniment data and voice data of the song advance, the lyrics of the song are displayed phrase by phrase as character strings to be inputted by a player (see FIGS. 14B, 15B).

The typing game progresses as the player inputs the lyrics of the displayed phrase using a keyboard 3, and when the song ends, the result of the typing game is calculated on the basis of various elements relating to typing such as the typing accuracy and input timing. In other words, in the typing game of the typing game apparatus 1, players test their typing skills while enjoying the songs that are played during the game.

During the game, promotion video images of the artist singing the song are displayed as the game progresses (as the song progresses) (see FIGS. 14A, 15A).

As shown in FIG. 2, the typing game apparatus 1 according to this embodiment is constituted by the keyboard 3, a first liquid crystal display 4, a second liquid crystal display 5, and so on, which are arranged on a main body housing 2.

The first liquid crystal display 4 is disposed on a front surface side of the main body housing 2 of the typing game apparatus 1. The first liquid crystal display 4 is a so-called liquid crystal display, and is provided at a slight rearward incline from the front surface side of the main body housing 2.

During execution of the typing game, the first liquid crystal display 4 displays lyrics data relating to the reproduced song, input results inputted by the player using the keyboard 3, and display relating to the typing game such as a score.

The second liquid crystal display 5 is disposed above the first liquid crystal display 4 in the main body housing 2. Similarly to the first liquid crystal display 4, the second liquid crystal display 5 is a so-called liquid crystal display.

During execution of the typing game, the second liquid crystal display 5 displays images relating to the reproduced song. For example, when the song of a certain singer is reproduced as the song, a promotion video (abbreviated to PV hereafter) of the singer relating to the song is displayed.

Speakers 7 are disposed on the left and right sides of the second liquid crystal display 5. The speakers 7 are apparatuses for producing the sound of the song and so on in the typing game apparatus 1. During execution of the typing game, the speakers 7 produce sound based on the voice data and musical accompaniment data of the reproduced song. The speakers 7 according to this embodiment correspond to sound producing means of the present invention.

Four external illumination LEDs 6 are arranged on each of the left and right side surfaces of the main body housing 2. The external illumination LEDs 6 are constituted by LEDs that are capable of full color illumination, and perform various illumination effects corresponding to the song that is reproduced on the typing game apparatus 1. Examples of these various illumination effects include varying the illumination colors of the total of eight external illumination LEDs 6, and switching the external illumination LEDs 6 on and off.

A coin insertion slot 8 and a card insertion slot 9 are provided below the first liquid crystal display 4 disposed on the front surface side of the main body housing 2. The coin insertion slot 8 accepts coins which are used as payment for playing the typing game on the typing game apparatus 1. A coin sensor 27 to be described below is provided in the interior of the coin insertion slot 8, and execution of the typing game on the typing game apparatus 1 becomes possible when the coin sensor 27 detects an inserted coin.

A card having a built-in IC chip (not shown), on which game results for the typing game and so on are recorded, is inserted into the card insertion slot 9. A card sensor 28 and a card reader/writer 29, to be described below, are provided in the interior of the card insertion slot 9. Hence, when the IC chip card is inserted into the card insertion slot 9, the IC chip card is detected by the card sensor 28, and game result data are read and written from and to the IC chip card by the card reader/writer 29.

The keyboard 3 is disposed on the front surface of the main body housing 2 so as to protrude to the front side. A plurality of keys 300 such as “A-Z”, “A-N” (Japanese syllabary characters), “0-9”, “period”, “comma”, and “ENTER” are arranged on the keyboard 3, and thus the keyboard 3 serves as means for inputting alphabetic characters, symbols, numerals, and so on corresponding to the respective keys 300, as well as means for selecting and determining songs and character types, and means for commanding the start of the typing game and so on.

Hence, during execution of the typing game, the game progresses when the player inputs the character strings displayed on the first liquid crystal display 4 using the corresponding keys 300.

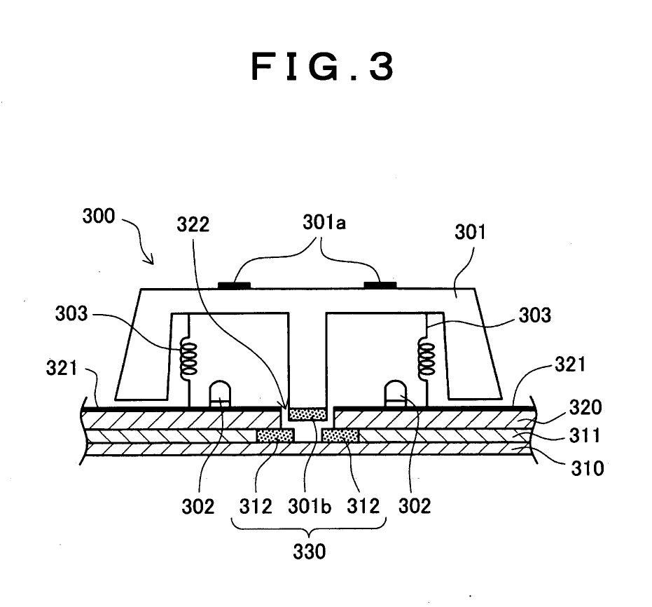

The constitution of the keys 300 arranged on the keyboard 3 will now be described. FIG. 3 is a schematic sectional view of any one of the plurality of keys 300 provided on the keyboard 3.

As shown in FIG. 3, the key 300 is constituted by a base plate 310, a switch circuit board 311, a light-emitting circuit board 320, a key top 301, a spring mechanism 303, and so on.

The switch circuit board 311 laid over the base plate 310 is provided with a pair of electrodes 312 disposed directly below the key top 301 near the center thereof.

The light-emitting circuit board 320 laid over the switch circuit board 311 is provided with an opening portion 322 for exposing the pair of electrodes 312, and an LED 302 that can be illuminated in full color is provided on the periphery of the opening portion 322.

The spring mechanism 303 is provided between the light-emitting circuit board 320 and key top 301, and the key top 301 is returned to the opposite side against the switch circuit board 311 by the spring mechanism 303. An electrode 301b is provided near the center of the key top 301 so as to protrude toward the switch circuit board 311 side. Hence, when the key top 301 is pressed down, the electrode 301b protruding from the key top 301 can be brought into contact with the pair of electrodes 312 provided on the switch circuit board 311, and thus the depression operation of the key top 301 can be transmitted as an electric signal which flows through the switch circuit board 311. In this manner, the three electrodes 301b, 312 constitute a key switch 330.

Note that the spring mechanism 303 may be constituted by an elastic body alone, an elastic body and a bridging mechanism, or in any other manner.

The key top 301 is formed from a translucent material (for example, translucent acrylic, translucent plastic, and so on), and key information 301a denoting an alphabetic character, numeral, symbol, or other character is printed in black on the planar portion thereof on the opposite side to the switch circuit board 311. The surface of the light-emitting circuit board 320 on the key top 301 side is also painted black.

Hence, when the LED 302 is extinguished, the black on the surface of the light-emitting circuit board 320 is projected onto the translucent key top 301, making the key information 301a printed in black on the key top 301, onto which the black on the surface of the light-emitting circuit board 320 is projected, difficult to recognize.

On the other hand, when the LED 302 is illuminated, the color of the illuminated LED 302 is projected onto the translucent key top 301, and hence the key information 301a printed in black on the illuminated key top 301 is easily recognizable.

On the keyboard 3, the key switch 330 in the key 300 is connected to a transmission circuit not shown in the drawing. The transmission circuit is connected to a CPU 10 of the typing game apparatus 1 via an interface unit 26 to be described below (to be referred to as I/O hereafter). By transmitting an electric signal from the key switch 330 of the depressed key 300 to the CPU 10 via the transmission circuit, the depressed key 300 can be specified. Note that the transmission circuit is installed in the aforementioned switch circuit board 311.

Also on the keyboard 3, the LED 302 in the key 300 is connected to a light emission control unit 24. The light emission control unit 24 is connected to the CPU 10 via the I/O 26. Hence, through the light emission control unit 24, the LED 302 in the key 300 can be illuminated in a color specified by the CPU 10.

Note that FIG. 3 illustrates a single key 300, but the other keys 300 arranged on the keyboard 3 have similar constitutions and functions.

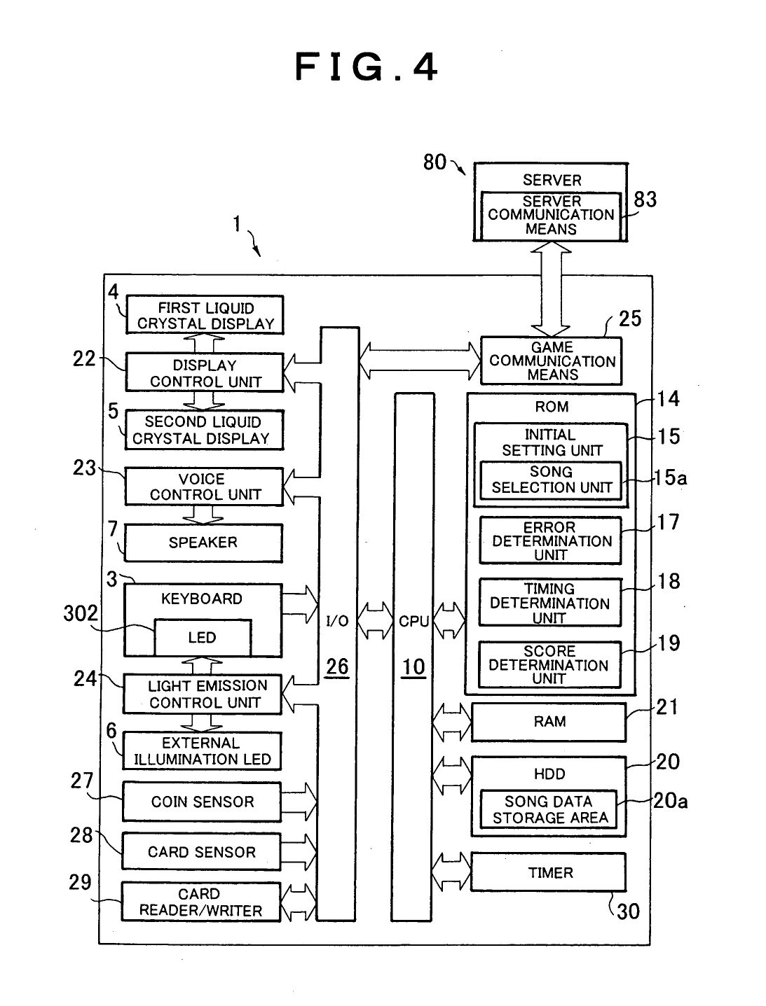

Next, a control system of the typing game apparatus 1 will be described in detail with reference to the drawings. FIG. 4 is a block diagram of the control system of the typing game apparatus 1.

As shown in FIG. 4, the control system of the typing game apparatus 1 is constituted by the CPU 10, which governs various control operations in the typing game apparatus 1 such as gaming processing operations and so on, and peripheral apparatuses (actuators) connected electrically to the CPU 10.

The CPU 10 is a central processing unit for performing calculation processing in accordance with various commands. The I/O 26 is a connection unit for electrically connecting the keyboard 3, first liquid crystal display 4, second liquid crystal display 5, speakers 7, and so on to the CPU 10 directly or indirectly. A ROM 14 is non-volatile read-only memory storing calculation programs for activating flowcharts to be described below. A RAM 21 is volatile read/write memory for storing data used by the CPU 10 during execution of the program temporarily, and storing song data stored in an HDD 20 temporarily.

The HDD 20 is a storage apparatus storing song data that are used during execution of the typing game in the typing game apparatus 1. A song data storage area 20a for storing a plurality of song data is formed in the HDD 20, and a plurality of song data used during execution of the typing game in the typing game apparatus 1 are stored in the song data storage area 20a.

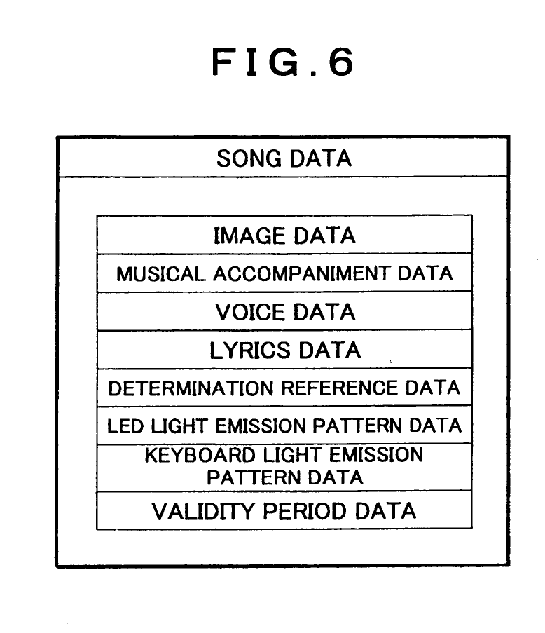

The song data stored in the song data storage area 20a will now be described in detail with reference to the drawings. FIG. 6 is an illustrative view of the song data.

As shown in FIG. 6, the song data used in the typing game apparatus 1 are constituted by image data, musical accompaniment data, voice data, lyrics data, determination reference data, LED light emission pattern data, keyboard light emission pattern data, and validity period data.

In the typing game apparatus 1 according to this embodiment, a typing game is played by inputting the lyrics of a song sung by an artist while the song is reproduced, and hence the aforementioned data constituting the song data correspond to the song.

More specifically, the image data of the song data are data relating to PV images of the artist corresponding to the song, the musical accompaniment data are music data relating to the musical accompaniment of the song produced by musical instruments and so on, and the voice data are data relating to the voice of the artist singing the song.

The lyrics data of the song data are text data corresponding to the lyrics of the song, which are used when the lyrics are displayed on the first liquid crystal display 4 phrase by phrase during execution of the typing game.

The determination reference data of the song data are reference data for determining whether the keys 300 pressed by the player during execution of the typing game are correct or not, and whether the depression timing is correct or not.

When the player types in accordance with the criteria of the determination reference data, a high score is obtained. On the other hand, when there is a discrepancy with the criteria of the reference data, for example when the key 300 pressed by the player is different to the key 300 prescribed by the reference data (a so-called mis-touch) or the key depression timing is far behind the progression of the song, a high score cannot be obtained at the end of the typing game.

The LED light emission pattern data and keyboard light emission pattern data of the song data are effects data indicating the illumination effect patterns produced on the typing game apparatus 1 during execution of the typing game.

More specifically, the LED light emission pattern data are data relating to the light emission patterns of the external illumination LEDs 6 which emit light with the progression of the song during execution of the typing game. Accordingly, the light emission patterns of the external illumination LEDs 6 are determined on the basis of the LED light emission pattern data, and controlled by the light emission control unit 24 to be described below to the respective light emission patterns (for example, emitted colors and illumination/extinction) of the eight external illumination LEDs 6.

The keyboard light emission pattern data are data relating to the light emission patterns of the LED 302 provided in each key 300 of the keyboard 3. Accordingly, the light emission patterns of the LED 302 in each key 300 of the keyboard 3 are controlled by the light emission control unit 24 on the basis of the keyboard light emission pattern data.

Examples of the light emission patterns of the keyboard 3 include a light emission pattern in which the keys 300 to be pressed are illuminated sequentially in a different color from the color of the entire keyboard 3, thereby helping a beginner of the typing game to press the correct keys, and a pattern in which the color of all of the keys 300 arranged on the keyboard 3 are varied in accordance with the image of the song.

The validity period data are data relating to the validity period of the song data, and are constituted by two sets of date data, namely a date on which the song data become usable (a usage start date), and a date on which the song data become unusable (a usage end date). The date data denoting the usage start date of the song data are known as validity period start data, and the date data denoting the usage end date of the song data are known as validity period end data. The validity period data are used to manage the validity periods of the song data for each song.

In the typing game apparatus 1 of this embodiment, the validity periods of the song data in the song data storage area 20a are managed by the validity period data and a timer 30 to be described below. In other words, the time measuring result of the timer 30 is compared to the validity period end data of the song data, and when the validity period has expired, it can be determined that the corresponding song data have reached the end of their validity period.

Returning to FIG. 4, the control system of the typing game apparatus 1 will be described.

Game communication means 25 convert signals issued by the typing game apparatus 1 into a transmittable format corresponding to the communication format of a telephone line, LAN cable, or similar, transmit the converted signals to the outside, receive transmitted signals, and return the signals to a format which can be read by the typing game apparatus 1. The game communication means 25 are connected wirelessly to the server communication means 83 of the server 80.

The HDD 20 is a storage apparatus comprising the song data storage area 20a for storing the song data that are received from the server 80.

A display control unit 22 is connected to the CPU 10 via the I/O 26, and serves to control the display content of the first liquid crystal display 4 and second liquid crystal display 5 in accordance with the calculation processing results of the CPU 10. More specifically, during execution of the typing game on the typing game apparatus 1, the lyrics data of the song data are displayed phrase by phrase on the first liquid crystal display 4. Further, control is performed on the basis of the input results of the keyboard 3 to display alphabetic characters corresponding to the input content on the first liquid crystal display 4. Meanwhile, control is performed to display a PV serving as the image data of the song data on the second liquid crystal display 5.

Further, when an error determination unit 17 to be described below determines that the depressed key 300 matches the key 300 corresponding to the alphabetic character displayed on the first liquid crystal display 4, the display control unit 22 modifies the background color of the matching character. In so doing, the player can confirm the characters of the displayed character string that have been inputted successfully, and hence key depression relating to the following character is made easier.

A voice control unit 23 is connected to the CPU 10 via the I/O 26 and also connected to the speakers 7. When the typing game is executed and the song data are read, the musical accompaniment data and voice data of the corresponding song data are converted into a voice signal by the voice control unit 23 and output by the speakers 7.

The light emission control unit 24 is connected to the CPU 10 via the I/O 26, and also connected to the external illumination LEDs 6 and the LED 302 of each key 300 arranged on the keyboard 3. When the song data are read in the CPU 10, the light emission control unit 24 controls the light emission patterns of the external illumination LEDs 6 and the LED 302 of each key 300 on the basis of the LED light emission pattern data and keyboard light emission pattern data of the corresponding song data.

The coin sensor 27 detects coins used as payment for executing the typing game on the typing game apparatus 1. The coin sensor 27 is disposed in the interior of the coin insertion slot 8 and connected to the CPU 10 via the I/O 26. Accordingly, the coin sensor 27 issues a coin insertion signal to the CPU 10 when coins are inserted into the coin insertion slot 8. The CPU 10 enables execution of the typing game after detecting a number of coin insertion signals corresponding to a predetermined number of coins.

The card sensor 28 detects whether or not an IC chip card has been inserted into the card insertion slot 9. The card reader/writer 29 is an apparatus for reading/writing data from and to the IC chip built into the IC chip card. The card sensor 28 and card reader/writer 29 are both disposed in the interior of the card insertion slot 9 and connected to the CPU 10 via the I/O 26. When it is confirmed by the card sensor 28 that the IC chip card has been inserted, the CPU 10 reads data from the IC chip or writes data to the IC chip via the card reader/writer 29.

The timer 30 serves as time measuring means for measuring the date and time and, as described above, is used to manage the song data in the song data storage area 20a. The timer 30 is connected to the CPU 10 via the I/O 26, and is referenced during the data management to be described below. In the typing game apparatus 1 according to this embodiment, processing to delete expired data is performed by checking the current time. The timer 30 is also used during processing to access the server in order to receive new song data when a set time is reached.

Note that the timer 30 is preferably constituted by a device which is constantly adjusted to the correct time, such as a wave clock having a function for correcting time errors automatically. It is conceivable that the arcade side could extend a validity period by tampering with the timer 30, but if the timer 30 is constantly adjusted to the correct date and time, such behavior intended to extend the validity period can be prevented, and hence management of the validity period can be performed rigorously.

Various functions of the ROM 14 for activating the following flowcharts will now be described in detail. The ROM 14 comprises an initial setting unit 15, the error determination unit 17, a timing determination unit 18, and a score determination unit 19.

The initial setting unit 15 comprises a song selection unit 15a, and sets the content of a game at the beginning of the game. More specifically, in this embodiment, the initial setting unit 15 sets the song data to be used in the typing game from the plurality of song data stored in the song data storage area 20a, and performs setting modifications relating to the typing game.

The song selection unit 15a causes the player to select a song title, reads the song data corresponding to the song title selected by the player from the HDD 20, and stores the song data temporarily in the RAM 21. More specifically, a song selection screen is displayed on the first liquid crystal display 4. The song selection screen displays the name of an artist and a plurality of song titles of the artist. When the player selects a desired song using the keyboard 3, the song data corresponding to the desired song are read from the HDD 20 and stored in the RAM 21. The song data stored in the RAM 21 are then reproduced in succession on the first liquid crystal display 4 and second liquid crystal display 5 and through the speakers 7, whereby a typing game based on the desired song is executed.

The error determination unit 17 determines whether or not the characters serving as the current input subjects have been inputted successfully by comparing input information corresponding to the characters making up the character string displayed on the first liquid crystal display 4 with the determination reference data of the song.

The timing determination unit 18 determines whether or not character input is performed in accordance with the progression of the song on the basis of the determination reference data. In other words, the timing determination unit 18 determines whether or not character input is performed at a substantially synchronous timing with the voice of the artist during the song. Note that as long as the voice of the artist and the character input timing match to a certain extent, the timing is determined to match.

The score determination unit 19 determines the game score of the player on the basis of the determination results of the error determination unit 17 and timing determination unit 18. For example, the game score of the player is determined on the basis of the typing accuracy and so on. More specifically, the game score is determined on the basis of the accuracy of character input during the typing game (the existence of so-called mis-touches), the accuracy of the character input timing, and the character input speed.

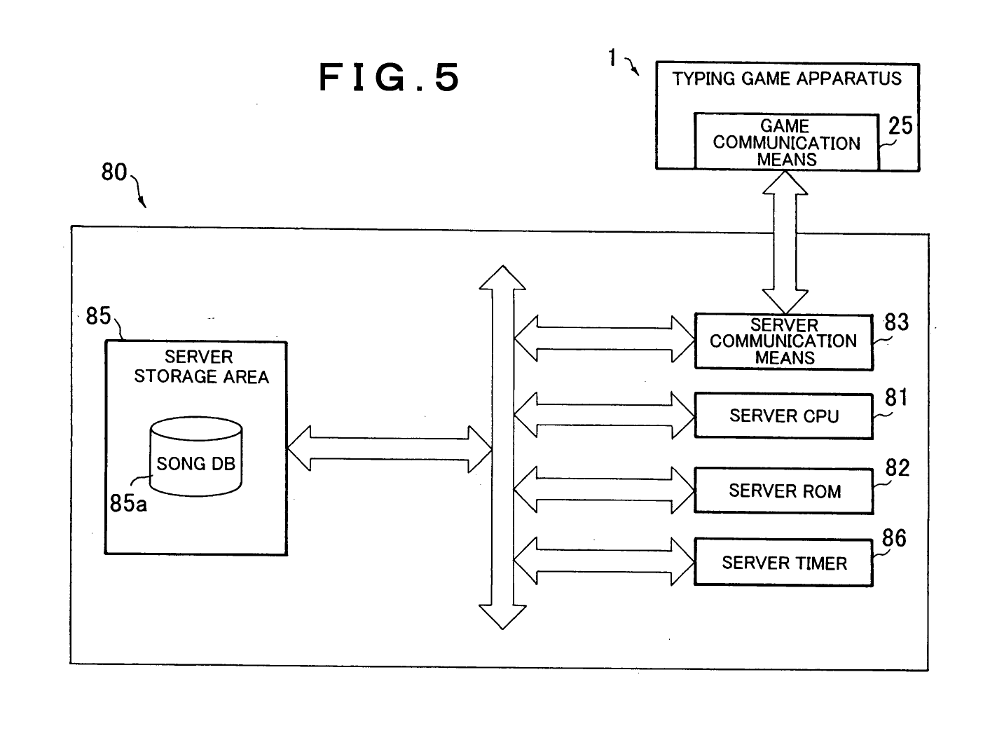

Next, the server 80 for distributing the song data to the typing game apparatus 1 as needed will be described in accordance with FIG. 5.

As shown in FIG. 5, the server 80 according to this embodiment is constituted by a server CPU 81, a server ROM 82, the server communication means 83, a server storage area 85, and a server timer 86.

The server CPU 81 is a central processing unit for executing a control program to perform various control operations of the server 80. Accordingly, the server CPU 81 lists the plurality of song data stored in a song DB 85a of the server storage area 85, to be described below, and performs operations to transmit the song data to the typing game apparatus 1 in the form of a data list, or transmit requested song data on the basis of a request from the typing game apparatus 1.

The server ROM 82 is non-volatile read-only memory storing control programs for performing the various control operations of the server CPU 81. Accordingly, the server ROM 82 stores various programs such as a program for creating list data of the song data in the song DB 85a.

The server communication means 83 perform bi-directional communication between the server 80 and typing game apparatus 1 via the network N. In other words, the server communication means 83 convert data issued by the server 80 into a signal in a transmittable format corresponding to the communication format of a telephone line, LAN cable, or similar, transmit the signal to the outside, receive a signal transmitted from the typing game apparatus 1, and return the signal to a format which can be read by the server 80. The server communication means 83 are connected to the game communication means 25 of the typing game apparatus 1 wirelessly via the network N.

The server storage area 85 is storage means which store various data used in the server 80, and the storage content thereof may be added to or deleted. The server storage area 85 is constituted by the aforementioned song DB 85a in which a plurality of the song data is stored. Thus the content of the song DB 85a can be updated by deleting song data having an expired validity period from the song DB 85a, and adding new song data.

By deleting song data having an expired validity period from the song DB 85a, these song data are no longer distributed, and since distributed song data are deleted on the basis of the timer 30 on the typing game apparatus 1 side, the song data validity periods can be managed rigorously. Further, by adding new songs, the songs that can be used in the typing game apparatus 1 are updated, and hence the player can be provided with new data constantly. In other words, the player's interest in the typing game apparatus 1 can be maintained.

The server storage area 85 also serves as storage means for storing various calculation results temporarily during execution of the control program of the server 80. Accordingly, when a request for song data distribution is received from the typing game apparatus 1, the server storage area 85 stores the identification information of the typing game apparatus 1, and reads the requested song data from the song DB 85a. Then, on the basis of the identification information, the requested song data are distributed to the typing game apparatus 1 which is the transmission source of the request signal via the server communication means 83.

The server timer 86 serves as time measuring means for measuring the date and time, and is used when song data newly added to the song DB 85a are distributed to the typing game apparatus 1. The server timer 86 is connected to the server CPU 81, and is referenced when creating a data list of the song data that can be distributed to the typing game apparatus 1 from the server 80. In the server 80 according to this embodiment, the song data added to the song DB 85a most recently (to be referred to as newest song data hereafter) can be identified by checking the current time. These data are then added to the data list of the song data as downloadable song data and transmitted to the typing game apparatus 1.

Similarly to the timer 30, the server timer 86 is preferably constituted by a device which is constantly adjusted to the correct time, such as a wave clock having a function for correcting time errors automatically.

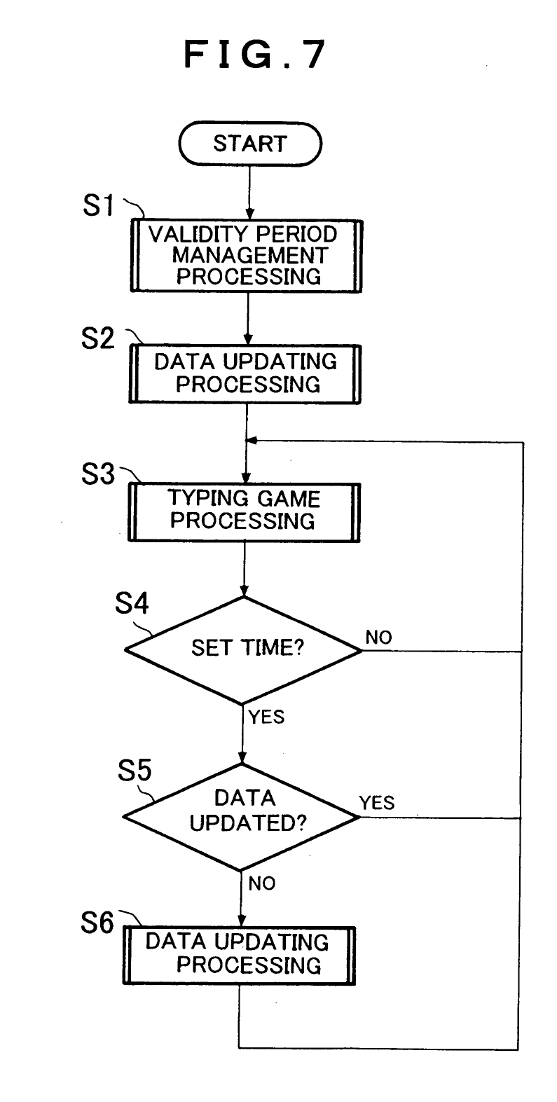

Next, an operation of the typing game apparatus 1 will be described with reference to FIGS. 7 to 13. First, a main control program of the typing game apparatus 1 will be described in detail with reference to FIG. 7. FIG. 7 is a flowchart of the main control program of the typing game apparatus 1.

As shown in FIG. 7, in the typing game apparatus 1 according to this embodiment, when power is supplied to the typing game apparatus 1, validity period management processing (S1) is performed. Validity period management processing (S1) is processing relating to the validity periods of the song data stored in the song data storage area 20a of the typing game apparatus. The validity period management processing (S1) will be described in detail below with reference to the drawings, and hence detailed description thereof has been omitted here.

Following the completion of the validity period management processing (S1), the CPU 10 performs data updating processing (S2). Data updating processing (S2) is processing for accessing the server 80 to receive new song data from the server 80. Likewise, the data updating processing (S2) will be described in detail below with reference to the drawings, and hence detailed description thereof has been omitted here.

Following the completion of the data updating processing (S2), typing game processing is performed in S3. Typing game processing (S3) relates to the execution of a typing game such as that described above. In other words, a player plays a typing game by depressing keys while the typing game apparatus 1 reproduces the PV images, musical accompaniment, and words of a song.

The typing game processing will be described in detail below with reference to the drawings, and hence description thereof has been omitted here.

Following the completion of the typing game processing (S3), a determination is made as to whether or not the timer 30 has reached a set time. Here, the set time is the timing at which the typing game apparatus 1 accesses the server to receive new song data. When the timer 30 has reached the set time (S4: YES), the routine advances to S5. If the timer 30 has not yet reached the set time (S4: NO), the routine returns to the typing game processing (S3).

In S5, a determination is made as to whether or not the song data stored in the song data storage area 20a have been updated. If data updating processing has already been performed such that the song data stored in the song data storage area 20a are updated (S5: YES), the routine returns to the typing game processing (S3). On the other hand, if data updating processing has not yet been performed such that the song data stored in the song data storage area 20a are not yet updated (S5: NO), the routine advances to S6. Here, a case in which data updating processing has not yet been performed indicates a case in which access to the server 80 is integrated at the time of the data updating processing (S2) so that the typing game apparatus 1 cannot access the server 80, a case in which the server 80 is halted due to an excessive load, or a case in which maintenance is being performed on the server 80.

In S6, to which the routine advances when the song data in the song data storage area 20a have not been updated, data updating processing is performed. This data updating processing (S6) is identical to that of S2, and hence description thereof has been omitted. Following the completion of the data updating processing (S6), the routine returns to the typing game processing (S3) and repeats the processing.

Through the processing of S4 to S6, new song data can be received by accessing the server 80 in accordance with the set time of the timer 30. Hence, even when the song data cannot be updated during the data updating processing (S2) that is performed directly after power is supplied to the typing game apparatus 1, the new song data that are added to the server 80 can be distributed and received reliably by accessing the server 80 again.

The various processes constituting the main control program of the typing game apparatus 1 will now be described in detail with reference to the drawings.

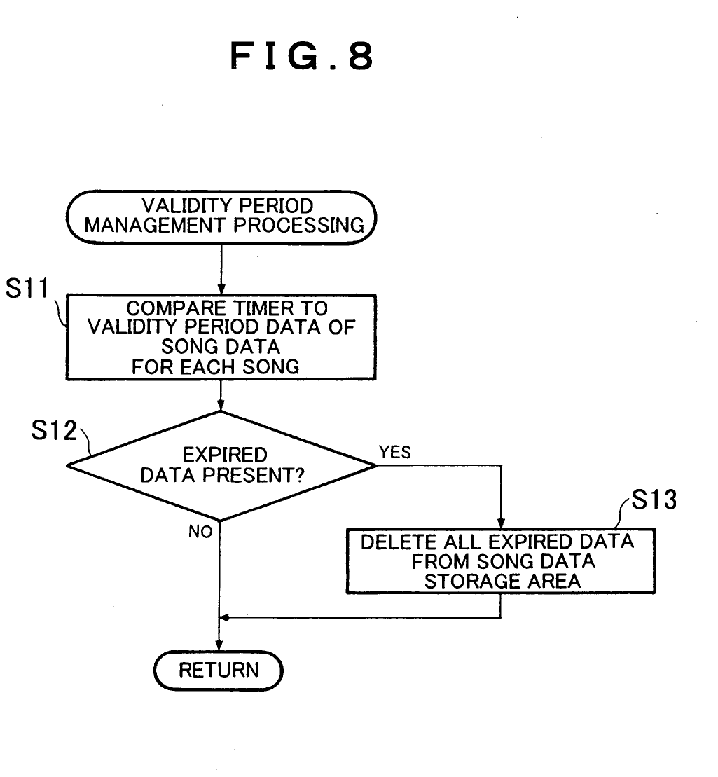

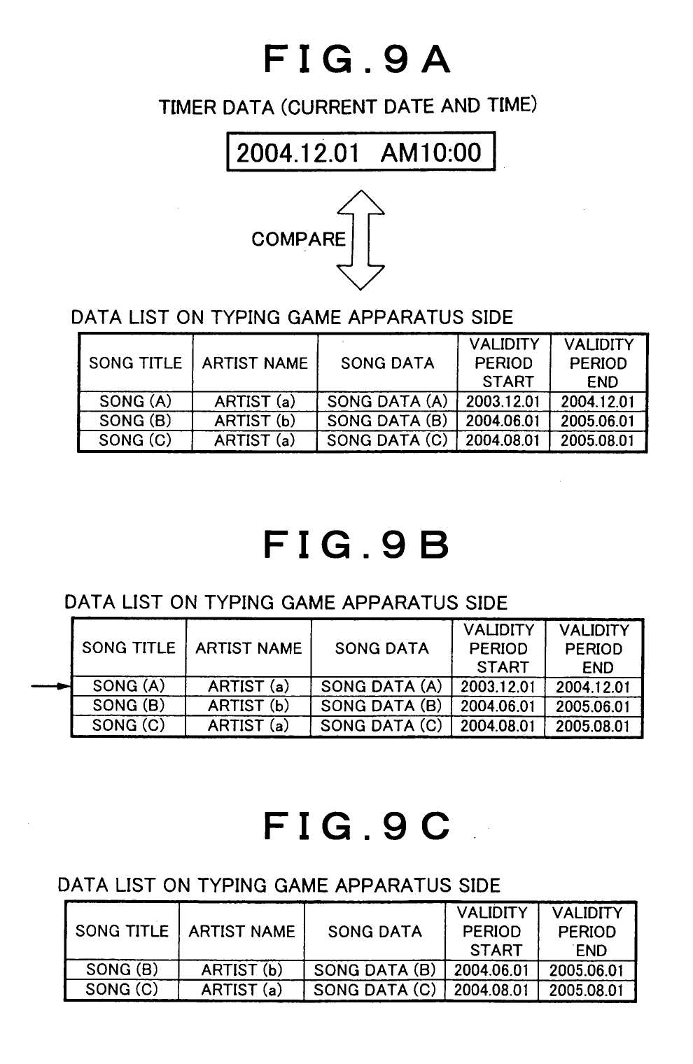

First, the validity period management processing (S1) that is performed initially when the main control program of the typing game apparatus 1 is executed will be described in detail with reference to FIGS. 8 and 9A to 9C. FIG. 8 is a flowchart of a validity period management processing program. FIGS. 9A to 9C are illustrative views relating to the validity period management processing.

When power is supplied to the typing game apparatus 1 and the validity period management processing (S1) begins, the CPU 10 reads the current date and time from the timer 30 in S11, and compares the current date and time with the validity period end data of the song data for each song stored in the song data storage area 20a. By comparing the current date and time shown on the timer 30 with the validity period end data of the song data for each song, the CPU 10 determines whether or not the validity period of the song data for each song has expired. After the validity periods of the song data for all of the songs stored in the song data storage area 20a have been checked, the routine advances to S12.

A specific example of the processing of S11 will now be described with reference to FIGS. 9A to 9C. In this specific example, it is assumed that power is supplied to the typing game apparatus 1 at 10 am, Dec. 1, 2004. Note that at this time, it is assumed that the song data for a “song (A)”, a “song (B)”, and a “song (C)” are stored in the song data storage area 20a of the typing game apparatus 1.

As shown in FIG. 9A, in this case the date and time data of the timer 30 indicate the current date and time, “10 am, Dec. 1, 2004”. Hence, in the processing of S11, the validity period of the song data for each song is checked by determining, in relation to the song data for each song, whether or not the validity period end data of the song data indicate “Dec. 1, 2004” or later.

In this specific example, as shown in the lower section of FIG. 9A, three sets of song data, relating to “song (A)”, “song (B)”, and “song (C)”, respectively, are stored in the song data storage area 20a. Accordingly, the validity periods are checked by comparing the validity period end data of the three sets of song data with the current date and time data of the timer 30. In this case, the validity period end data of the “song (A)” is “Dec. 1, 2004”, and it is therefore determined that the validity period of the song data for the “song (A)” has expired (see FIG. 9B, shown by an arrow). After the validity periods of all of the song data in the song data storage area 20a have been checked, the routine advances to S12.

In S12, a determination is made as to whether or not song data having an expired validity period (to be referred to as expired data hereafter) have been detected as a result of the processing of S11. When expired data exist in the song data storage area 20a (S12: YES), the routine advances to S13. On the other hand, if no expired data exist in the song data storage area 20a (S12: NO), this indicates that all of the song data in the song data storage area 20a are within their validity periods and therefore usable. In this case, the validity period management processing (S1) ends and the routine advances to S2.

In the specific example described above, the validity period of the song data for the “song (A)” has expired, and therefore the song data for the “song (A)” correspond to expired data (S12: YES). Hence, in the case of the specific example, the routine advances to the processing of S13.

In S13, all of the song data determined to be expired data are deleted from the song data in the song data storage area 20a. In the above specific example, the song data for the “song (A)” are deleted from the song data storage area 20a (see FIG. 9C). When all of the expired data have been deleted from the song data storage area 20a, the validity period management processing (S11) ends and the routine advances to S2.

Thus, when power is supplied to the typing game apparatus 1, the validity periods of all of the song data in the song data storage area 20a are checked, and all of the expired data are deleted from the song data storage area 20a. Therefore, the validity periods of the song data can be managed rigorously. Furthermore, the expired data can be deleted automatically by supplying power, and hence a game company which supplies the typing game apparatus 1 or the arcade in which the typing game apparatus 1 is disposed need not perform complicated operations to manage the validity periods of the song data.

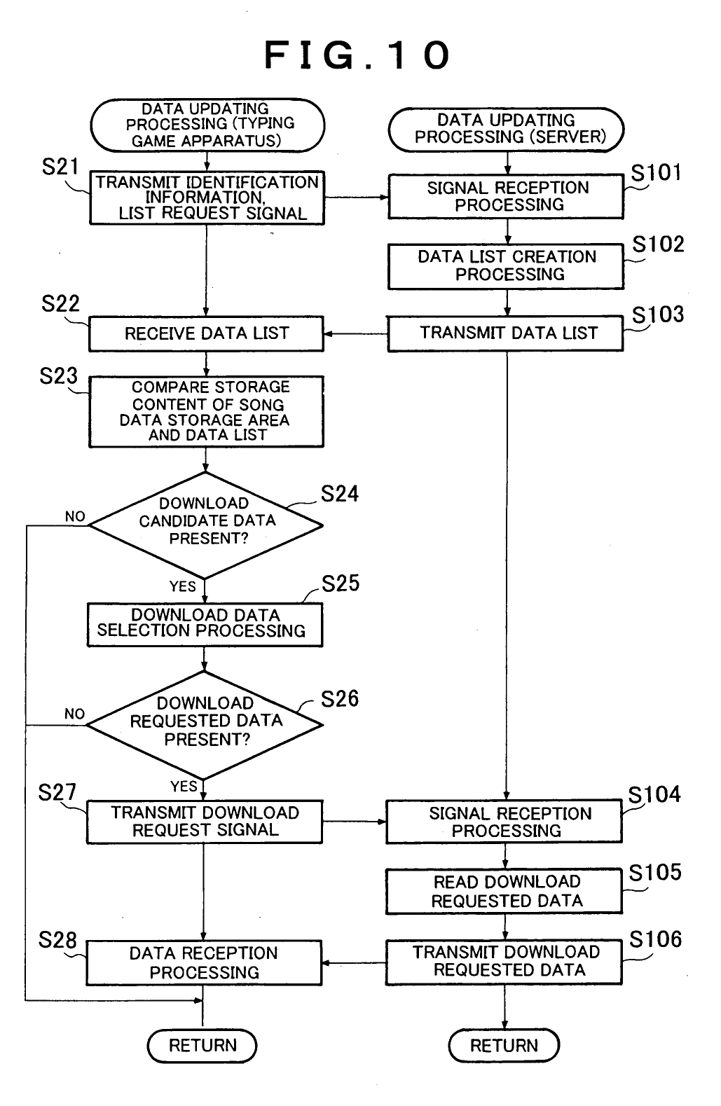

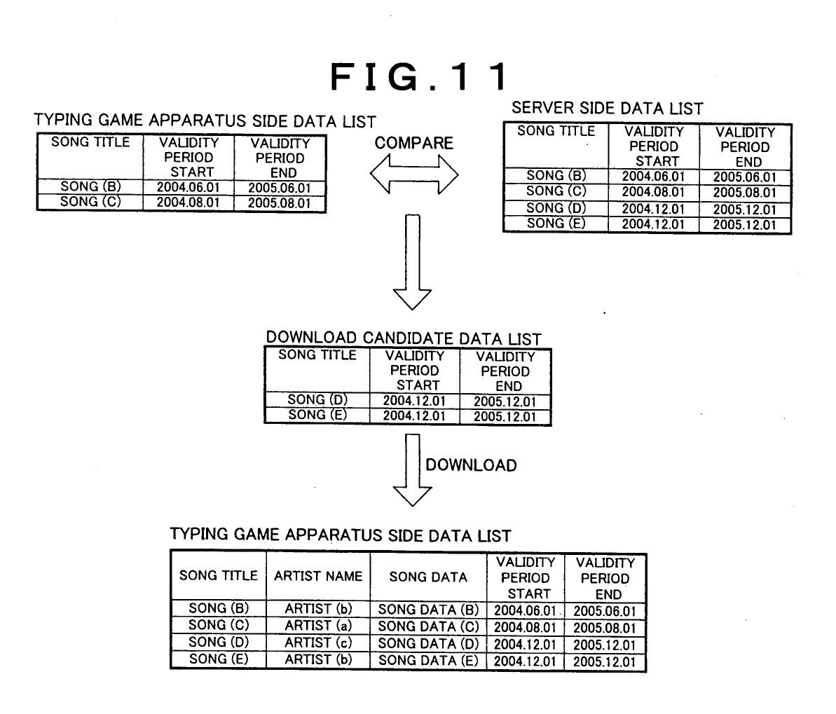

Next, the data updating processing (S2) that is performed after the completion of the validity period management processing (S1) will be described in detail with reference to FIGS. 10 and 11. FIG. 10 is a flowchart showing processing that is performed between the typing game apparatus 1 and the server 80 during the data updating processing. FIG. 11 is an illustrative view of the data updating processing.

When the typing game apparatus 1 advances to the data updating processing (S2), first, in S21, the CPU 10 transmits to the server 80 a list request signal requesting transmission of the song data list relating to the corresponding typing game apparatus 1, and identification information identifying each typing game apparatus 1 individually.

Upon reception of the list request signal and identification information transmitted by the typing game apparatus 1, the server CPU 81 performs signal reception processing (S101). Signal reception processing is processing relating to the received list request signal and identification information. More specifically, the server CPU 81 stores the list request signal and identification information, which are received by the server communication means 83, in the server storage area 85.

Next, the server CPU 81 advances to data list creation processing (S102), which is performed on the basis of the identification information and list request signal stored in the server storage area 85 as a result of the signal reception processing (S101).

In the data list creation processing, first the song data (to be referred to as using song data hereafter) that are in use in the typing game apparatus 1 that is the transmission source of the list request signal are read on the basis of the identification information stored in the server storage area 85. Next, the server CPU 81 compares the validity period start data of all of the song data stored in the song DB 85a with the current date and time data shown on the server timer 86. By comparing the validity period start data of all of the song data with the current date and time data shown on the server timer 86, the newest song data that have been added most recently at the present time can be identified from among all of the song data.

Then, in the data list creation processing (S102), a data list is created from the using song data in use in the typing game apparatus 1 which is the transmission source of the list request signal, and the newest song data (see FIG. 11).

To describe the data list creation processing (S102) further using a specific example, it is assumed that the “song (B)” and “song (C)” exist in the typing game apparatus 1 as using song data, as shown in FIG. 11. The newest song data added most recently to the server 80 at the present time are song data for a “song (D)” and a “song (E)”.

Hence, the data list created in the data list creation processing (S102) contains the song data for four songs, “song (B)”, “song (C)”, “song (D)”, and “song (E)” (see FIG. 11).

Following creation of the data list in the data list creation processing (S102), the server CPU 81 transmits the created data list to the typing game apparatus 1 which is the transmission source of the list request signal on the basis of the identification information stored in the server storage area 85 (S103).

Meanwhile, the CPU 10 receives the data list transmitted by the server 80, and stores the data list in the RAM 21 (S22). Next, in S23, the storage content of the song data storage area 20a is compared to the data list stored in the RAM 21 (see upper section of FIG. 11). Here, the storage content of the song data storage area 20a denotes the song data that are stored for current use in the typing game apparatus 1. By comparing the song data that are currently stored in the song data storage area 20a of the typing game apparatus 1 with the list of using song data contained in the data list, the state of song data distribution can be confirmed on the side of the arcade in which the typing game apparatus 1 is disposed and the side of the server 80 which distributes the song data.

The data list also contains a list of the newest song data. When these newest song data are not stored in the song data storage area 20a on the typing game apparatus 1 side, or in other words when the newest song data have not yet been distributed and received, the newest song data are treated as download candidate data, which are song data that can be distributed by the server 80 and received.

To describe the processing of S23 using the above specific example, the CPU 10 compares the storage content of the song data storage area 20a on the typing game apparatus 1 side with the data list received from the server 80, as shown in the upper section of FIG. 11. In so doing, it is possible to determine that the “song (B)” and “song (C)” stored in the song data storage area 20a match the “song (B)” and “song (C)” serving as the using song data in the data list from the server 80.

The “song (D)” and “song (E)” in the data list are song data newly added to the server 80 which are not yet stored in the song data storage area 20a, and therefore the “song (D)” and “song (E)” are treated as download candidate data.

Following the processing of S23, the presence of download candidate data is determined in S24. When download candidate data exist, or in other words when song data such as newest song data that do not exist in the song data storage area 20a are determined to be download candidate data (S24: YES), the routine advances to S25. On the other hand, if no download candidate data exist, or in other words if the storage content of the song data storage area 20a matches the data list from the server 80 perfectly (S24: NO), the data updating processing (S2) ends as is and the routine advances to S3.

In S25, download data selection processing is performed. In this download data selection processing, song data to be distributed by the server 80 are selected from the download candidate data. When the routine advances to the download data selection processing, first, data indicating the song data determined to be download candidate data in S23 are displayed on the first liquid crystal display 4. For example, a list containing the song title, validity period start data, and validity period end data of the song data for each song is displayed, as shown in the middle section of FIG. 11. Here, a manager of the typing game apparatus 1 on the arcade side uses the keyboard 3 to select the required song data. Following selection of the song data, the routine advances to S26. Hereafter, song data selected from the download candidate data in the download data selection processing (S25) for distribution by the server 80 will be referred to as download requested data.

In the download data selection processing, when the keyboard 3 is not operated for a predetermined time period (three minutes, for example), it is assumed that the arcade side does not require distribution of any of the song data, and hence the routine advances to S26.

In S26, a determination is made as to the presence of download requested data. When song data selected as download requested data in the download data selection processing (S25) are present (S26: YES), the routine advances to S27. In S27, a download request signal requesting downloading of the download requested data, and identification information identifying the corresponding typing game apparatus 1, are transmitted to the server 80.

If, on the other hand, no download requested data are present, or in other words when none of the download candidate data are selected in the download data selection processing (S25) (S26: NO), no request is placed with the server 80 for the distribution of song data, and hence the data updating processing (S2) ends, whereupon the routine advances to S3.

The processing of S25 to S27 will now be described on the basis of FIG. 11 using the above specific example.

In the download data selection processing (S25), the “song (D)” and “song (E)” are displayed on the first liquid crystal display 4 as a list of download candidate data, as shown in the center of FIG. 11. The manager of the typing game apparatus 1 then operates the keyboard 3 to select song data to be used in a game on the typing game apparatus 1.

It is assumed in the specific example that the song data of “song (D)” and “song (E)”, which are the newest song data, are selected for downloading. Hence, the song data for the “song (D)” and “song (E)” become download requested data, and in S27, a download request signal requesting distribution of the song data for “song (D)” and “song (E)” is transmitted to the server 80 together with the identification information of the corresponding typing game apparatus 1.

Upon reception of the download request signal and identification information from the typing game apparatus 1, the server CPU 81 performs signal reception processing (S104). Signal reception processing is processing relating to the download request signal and identification information. More specifically, the server CPU 81 stores the download request signal and identification information, which are received by the server communication means 83, in the server storage area 85.

Then, on the basis of the download request signal stored in the server storage area 85 in the signal reception processing (S104), the server CPU 81 reads the requested song data from the song DB 85a (S105). According to the specific example, the song data for “song (D)” and “song (E)” are read from the song DB 85a.

Then, on the basis of the identification information stored in the server storage area 85, the song data read in S105 are transmitted to the typing game apparatus 1 which is the download request source via the server communication means 83.

The song data transmitted via the server communication means 83 are received by the game communication means 25. The CPU 10 then stores the received song data in the song data storage area 20a. In terms of the aforementioned example, upon reception of the song data for “song (D)” and “song (E)”, the song data for “song (B)”, “song (C)”, “song (D)”, and “song (E)” are stored in the song data storage area 20a, as shown in the lower section of FIG. 11.

Thus, in the typing game apparatus 1 according to this embodiment, song data having an expired validity period are deleted, while song data such as the newest song data added to the server 80 can be distributed and received. In other words, the validity periods of the song data are managed rigorously while new songs are distributed to the typing game apparatus 1 as needed. Hence, the player never tires of the typing game apparatus 1.

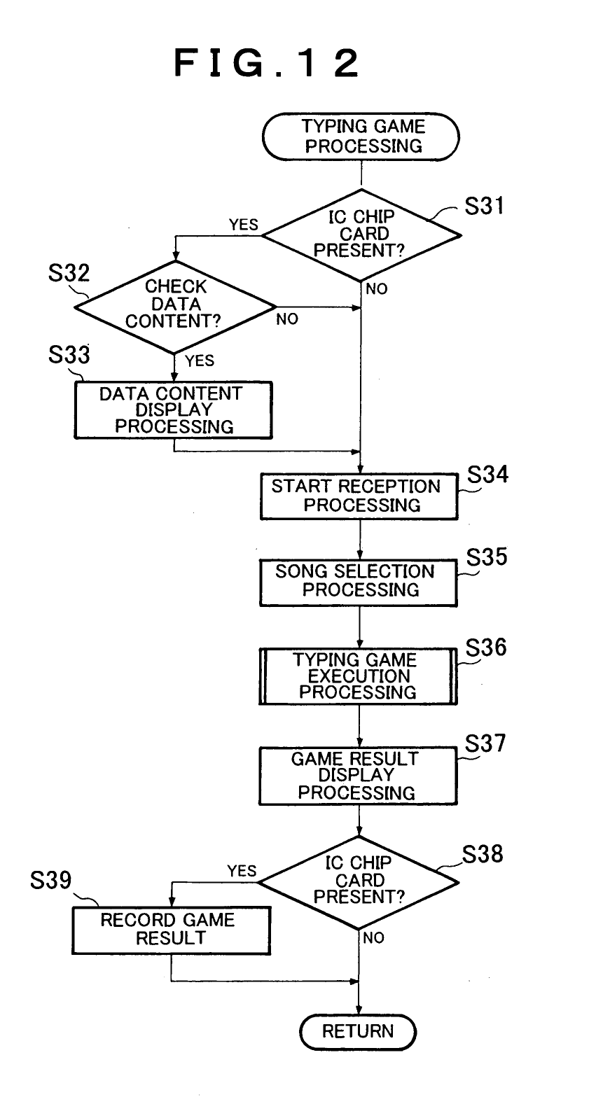

Next, the typing game processing (S3) that is performed following the completion of the data updating processing (S2) will be described in detail with reference to the drawings. FIG. 12 is a flowchart of a typing game processing program.

When the routine advances to the typing game processing (S3), first, in S31, the presence of an IC chip card is determined. In other words, a determination as to whether or not an IC chip card has been inserted into the card insertion slot 9 is made on the basis of the detection result of the card sensor 28 provided in the interior of the card insertion slot 9. When an IC chip card is present in the card insertion slot 9 (S31: YES), the routine advances to S32. When no IC chip card is present in the card insertion slot 9 (S31: NO), the routine advances to start reception processing (S34).

When an IC chip card is inserted into the card insertion slot 9 (S31: YES), a question asking “should the storage content of the IC chip be checked?” is displayed on the first liquid crystal display 4 to determine whether or not the data content is to be checked (S32).

When the player uses the keyboard 3 to select the option of checking the storage content of the IC chip card (S32: YES), the storage content of the IC chip is read via the card reader/writer 29 and displayed on the first liquid crystal display 4 (S33). Once the storage content of the IC chip has been displayed, the routine advances to the start reception processing (S34). On the other hand, when the player uses the keyboard 3 to select not to check the storage content of the IC chip card (S32: NO), the routine advances directly to the start reception processing (S34).

In the start reception processing (S34), processing relating to the start of the typing game, such as coin reception processing for initializing the storage content of the RAM 21 and executing the typing game or environment setting relating to the difficulty level of the typing game and so on, is performed.

Following the completion of the start reception processing (S34), song selection processing (S35) is performed. In the song selection processing (S35), processing is performed to select the song data to be used in the current typing game from among the song data stored in the song data storage area 20a. More specifically, the song titles of all of the song data stored in the song data storage area 20a are displayed on the first liquid crystal display 4, and the player uses the keyboard 3 to select a song, thereby determining the song data to be used in the current typing game.

In terms of the above example, during song selection processing, four song titles, i.e. “song (B)”, “song (C)”, “song (D)”, and “song (E)”, are displayed on the first liquid crystal display 4, and the player uses the keyboard 3 to select a song from among these songs to be used in the current typing game.

When the song to be used in the typing game has been determined in the song selection processing (S35), the routine advances to typing game execution processing (S36). The typing game execution processing (S36) relates to the progression of the typing game and will be described in detail below. Therefore, description thereof has been omitted here. Following the completion of the typing game execution processing (S36), the routine advances to S37.

In S37, game result display processing is performed to display the result of the typing game on the first liquid crystal display 4. In the game result display processing, a game result of the typing game performed in the typing game execution processing (S36), which is calculated from factors such as character input mistakes and deviations between the song and the character input timing, is displayed.

Following the game result display processing (S37), a determination is made as to whether or not the IC chip card is inserted into the card insertion slot 9 in S38. When the IC chip card is inserted into the card insertion slot 9 (S38: YES), the game result of the current typing game is recorded onto the IC chip via the card reader/writer 29 (S39). When the game result has been recorded onto the IC chip, the typing game processing (S3) ends.

If, on the other hand, no IC chip card is inserted into the card insertion slot 9 (S38: NO), NO), the game result is deleted from the RAM 21 without being recorded onto the IC chip, and then the typing game processing (S3) ends.

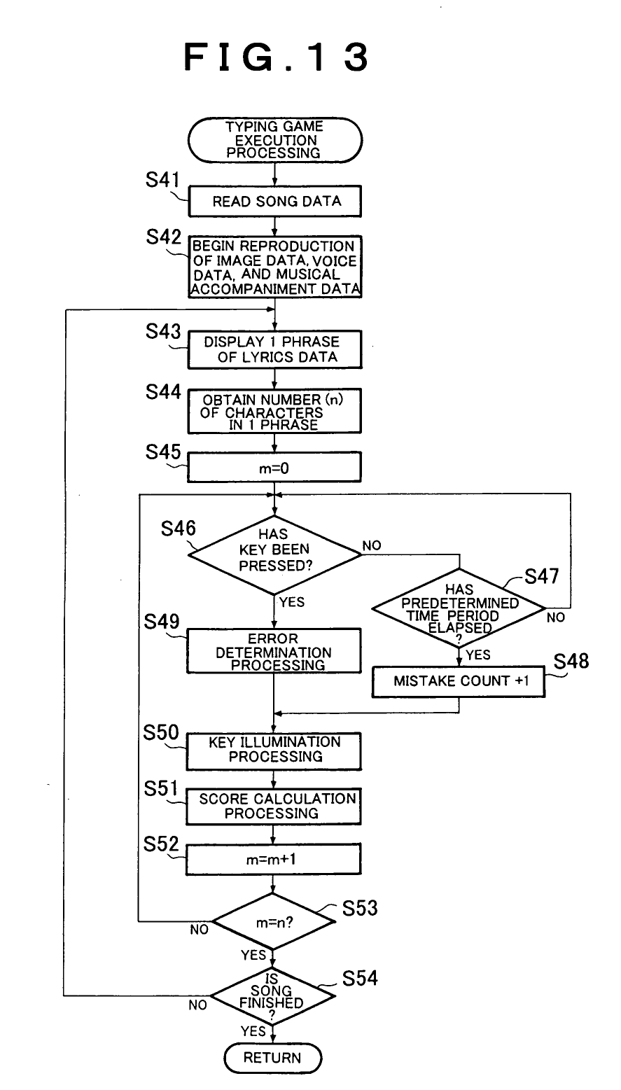

The typing game execution processing that is executed in S36 of the typing game processing (S3) will now be described in detail on the basis of the drawings. FIG. 13 is a flowchart of a typing game execution processing program.

As shown in FIG. 13, when the typing game execution processing program is executed, first, in S41, the song data selected in the song selection processing (S35) are read from the song data storage area 20a (S41).

Reproduction of the image data, voice data, and musical accompaniment data constituting the read song data is then begun (S42). At this time, images relating to the PV of the song in the image data are displayed on the second liquid crystal display 5, while the voice data and musical accompaniment data are produced through the speakers 7.

When reproduction of the image data, voice data, and musical accompaniment data constituting the song data begins, one phrase, which is a part of the lyrics data constituting the song data, is displayed on the first liquid crystal display 4 (S43).

A number (n) of characters of the phrase of lyrics data displayed on the first liquid crystal display 4 is then obtained (S44). For example, when the phrase “I WILL NO LONGER HESITATE” is displayed as the phrase of the lyrics data (see FIG. 14B), the number of characters in the phrase is 21, and hence 21 serves as the number (n) of characters constituting the phrase. After obtaining the number (n) of characters constituting the phrase, m, which denotes the number of characters in the phrase that have been input, is set to 0 (S45).

In S46, a determination is made as to whether or not any of the keys 300 on the keyboard 3 have been pressed in relation to the character string of the phrase of lyrics data displayed on the first liquid crystal display 4. When any one of the keys 300 on the keyboard 3 has been pressed (S46: YES), the routine advances to S49.

On the other hand, when none of the keys 300 have been pressed (S46: NO), a determination is made as to whether or not a predetermined time period has elapsed from the point in time at which the character string of the lyrics phrase was displayed or the point in time at which the previous character was inputted (S47). If the predetermined time period has not elapsed (S47: NO), the routine returns to S46 to receive character input by the keys 300. If no key 300 is pressed before the predetermined time period elapses (S47: YES), it is assumed that the input timing for inputting the current character of the lyrics phrase has been missed, and therefore an input mistake is assumed to have been made in relation to the character. Hence, 1 is added to the mistake count, which is then stored in the RAM 21 (S48). Note that the value of the mistake count is used in subsequent score calculation processing (S51) to calculate the game score. After 1 has been added to the mistake count and the mistake count has been stored in the RAM 21, the routine advances to S50.

When the key 300 is pressed within the predetermined time period (S46: YES), the routine advances to S49, where error determination processing is performed in relation to the depressed key 300. In the error determination processing (S49), determinations are made on the basis of the error determination unit 17, timing determination unit 18, and the determination reference data in the corresponding song data as to whether or not the correct key 300 has been pressed and whether or not the depression timing is accurate.

More specifically, in the error determination processing, the determination reference data are referenced by the error determination unit 17 to determine whether or not the keys 300 corresponding to the lyrics of the song have been pressed, and the determination reference data are referenced by the timing determination unit 18 to determine the degree to which the depression timing of the keys 300 matches the progression of the song.

To describe this in terms of the above phrase “I WILL NO LONGER HESITATE”, for example, if the “W” key 300 is pressed at the same time as the singer of the song produces the “W” sound of “I WILL NO LONGER HESITATE”, then the highest rating is applied in the error determination processing.

Following the completion of the error determination processing (S49), key illumination processing is performed in S50. Key illumination processing is processing for illuminating the LED 302 disposed in the interior of each key 300 on the keyboard 3. At this time, when the depressed key 300 is correct, the LED 302 is illuminated in blue, and when the depressed key 300 is incorrect, the LED 302 of the depressed key 300 is illuminated in red.

Note that in this embodiment, the keys 300 are illuminated in two colors, “red” and “blue”, depending on whether the correct key 300 is pressed or not, but the present invention is not limited thereto, and the illumination color of the key 300 may be varied in accordance with the accuracy of the depression timing as well as the correctness of the depressed key 300. For example, a constitution is possible whereby the key 300 is illuminated in “blue” when the correct key 300 is pressed with accurate timing, the key 300 is illuminated in “green” when the correct key 300 is pressed but the depression timing is slightly out of synchronization, and the key 300 is illuminated in “orange” when the correct key 300 is pressed but the depression timing is greatly out of synchronization.

Following the completion of the key illumination processing (S50), the routine advances to S51, where score calculation processing is performed. In the score calculation processing (S51), the game score is calculated on the basis of the character input results obtained in the processing of S46 to S49. In this embodiment, when the predetermined time period elapses before character input is performed (S47) or when the wrong key 300 is pressed, a score of zero is granted. When it is determined by the error determination unit 17 and timing determination unit 18 that the correct key 300 has been pressed with accurate timing, a score of 200 points is granted. When the depression timing is slightly out of synchronization, a score of 100 points is granted, and when the depression timing is greatly out of synchronization, a score of 50 points is granted.

Following the completion of the score calculation processing (S51), 1 is added to m, denoting the number of characters inputted at present (S52). In S53, a determination is made as to whether or not m, denoting the number of characters inputted at present, is equal to the value of the number (n) of characters constituting the phrase of the lyrics. When the numerical values of m and n are equal, or in other words when input of the current lyrics phrase is complete (S53: YES), the routine advances to S54. If, on the other hand, input of the characters constituting the phrase is not complete (S53: NO), the routine returns to S46 to input the next character.

In S54, a determination is made as to whether or not the song reproduced in the typing game is finished. The determination as to whether or not the song is finished is made according to whether or not input processing for all of the phrases of the lyrics data displayed on the first liquid crystal display 4 is complete, and whether or not reproduction of the image data, voice data, and musical accompaniment data constituting the song data is complete. When the song is finished (S54: YES), the typing game execution processing (S36) ends.

If the song is not yet finished (S54: NO), the routine returns to S43 in preparation for input of the next phrase, and the typing game execution processing (S36) continues.

The typing game is executed in the typing game apparatus 1 by executing the programs described above. As shown in FIGS. 14, 15, the PV corresponding to the song data is displayed on the second liquid crystal display 5, and a game screen including one lyrics phrase as a string of characters to be inputted is displayed on the first liquid crystal display 4.

For example, when a song “Δ×□” by an artist “ΔΔΔΔ” is selected in the song selection processing (S35), a screen such as that shown in FIG. 14B is displayed on the first liquid crystal display 4, and a screen such as that shown in FIG. 14A is displayed on the second liquid crystal display 5.

On the other hand, when a song “◯×Δ” by an artist “◯◯××” is selected in the song selection processing (S35), a screen such as that shown in FIG. 15B is displayed on the first liquid crystal display 4, and a screen such as that shown in FIG. 15A is displayed on the second liquid crystal display 5.

As can be seen from a comparison of FIGS. 14 and 15, the atmosphere of the typing game is completely different depending on the selected artist and song. Hence the player can enjoy typing games with different atmospheres by selecting artists and songs according to his/her taste and mood of the day. Since the PV corresponding to the selected song is displayed on the second liquid crystal display 5, as shown in FIGS. 14A and 15A, the player can enjoy the typing game while enjoying the music.

Moreover, in order to view the PV of the player's preferred song on the second liquid crystal display 5, the player must type accurately without looking at the lyrics displayed on the first liquid crystal display 4 and his/her hands, and therefore so-called blind touch typing can be practiced while learning the lyrics of the selected song.

As described above, the typing game apparatus 1 according to this embodiment comprises the timer 30 which is capable of measuring the current date and time, and song data relating to the execution of the typing game in the typing game apparatus 1 and being related to a validity period which is set as validity period data are stored in the song data storage area 20a of the HDD 20.

By having the CPU 10 execute the validity period management processing program for managing the validity period of the song data, song data having an expired validity period can be identified in the typing game apparatus 1 according to this embodiment and deleted automatically from the song data storage area 20a.

As a result, the song data having the expired validity period can no longer be used by the typing game apparatus 1. Hence, the arcade in which the typing game apparatus 1 is disposed and the song data provider can both perform easy and rigorous management of the validity periods of the song data.

Further, the gaming system 100 is constituted by the typing game apparatuses 1, which are connected to the network N via the game communication means 25, and the server 80, which is connected to the network N in a similar manner via the server communication means 83.

The server 80 comprises the song DB 85a storing the song data that can be distributed to the typing game apparatuses 1 of the gaming system 100, and is capable of creating a data list of the song data of the typing game apparatuses 1 in the gaming system 100.

Hence, when a song data distribution request is transmitted to the server 80 by the typing game apparatus 1, the data list of the song data corresponding to the typing game apparatus 1 is transmitted from the server 80.

The CPU 10 compares the received data list to the storage content of the song data storage area 20a to identify song data that do not exist in the song data storage area 20a, and then requests these song data from the server so that the song data can be added to the song data storage area 20a.

Thus new game data can be added to the typing game apparatus as needed, providing the typing game with a sense of freshness at all times in order to maintain the interest of the player.

Further, when a fault occurs during distribution of the song data such that the song data cannot be received by the typing game apparatus 1, the song data that are not received can be specified easily by comparing the data list created on the server 80 side with the storage content of the song data storage area 20a. Hence, the arcade in which the typing game apparatus 1 is disposed can request transmission of the song data that are not received by means of a simple operation, thereby facilitating management of the song data.

Further, the typing game apparatus 1 according to this embodiment is capable of executing a typing game using song data that are based on a song sung by an artist who is currently popular. In other words, the musical accompaniment and vocal of the song are reproduced through the speakers 7 while the PV of the song is displayed on the second liquid crystal display 5. The lyrics of the song are displayed on the first liquid crystal display 4 as character strings to be inputted.

Thus the player is able to play a typing game based on the song in which he/she is most interested while enjoying the music. As a result, the typing game can be played with a greater sense of affinity.

Note that the present invention is not limited to the embodiment described above, and may be subjected to various modifications within a scope that does not depart from the spirit of the invention. For example, in this embodiment only the song data that are newly added to the song DB 85a of the server 80 can be distributed to the typing game apparatus 1, but the present invention is not limited to this aspect.

More specifically, song data may be distributed in accordance with the wishes of the arcade in which the typing game apparatus 1 is disposed. For example, the manager of the arcade in which the typing game apparatus 1 is disposed specifies the song data he/she wishes to be distributed by electronic mail, FAX, or the like, whereby the specified song data is added to the data list transmitted from the server 80, thus responding to the wishes of the arcade.

As a result, the songs that can be used in the typing game may be different in each arcade, even when identical typing game apparatuses 1 are disposed in the arcades, and hence the typing game can be executed using songs which correspond to the clientele of the respective arcades.

Further, in the typing game apparatus 1 according to this embodiment, song data are deleted on the basis of the validity period of the song data, but a constitution may be provided in which notification of song data coming to the end of their validity period is provided prior to the end of the validity period (one month in advance, for example). In so doing, the arcade in which the typing game apparatus 1 is disposed can be notified of song data that are about to expire in advance and determine whether or not to extend the validity period of the song data, or in other words give sufficient consideration as to whether or not to accept redistribution of the song data.

Furthermore, in the typing game apparatus 1 according to this embodiment, the gaming system 100 is constituted by connecting a plurality of the typing game apparatuses 1 and the server 80 to each other via the network N, but the present invention is not limited to this aspect. For example, in an arcade in which a plurality of the typing game apparatuses 1 is disposed, a management server may be provided between the typing game apparatuses 1 and the server 80 for managing the typing game apparatuses 1 disposed in the arcade, and the management server may be connected to the server 80 via the network N.

Further, a single server 80 is provided in this embodiment, but a central server system having a plurality of servers may be employed.

As described above, the typing game apparatus according to the present invention comprises storage means for storing game data comprising image data including a character string to be inputted, music data, and validity period data indicating the validity period of the image data and music data. Determination means determine whether or not the validity period of the game data stored in the storage means has expired on the basis of time measuring means and the validity period data, and game data having an expired validity period can be deleted from the storage means by data management means. Thus, management of the validity periods of the game data can be performed rigorously without being troublesome to the manager of the typing game apparatus.

The typing game apparatus according to the present invention further comprises communication means for receiving data from a server comprising a storage unit storing a plurality of the game data and management data creation means for creating management data for the game data existing in the storage unit.

The determination means determine the presence of non-obtained game data which do not exist in the storage means by comparing the management data with the storage content of the storage means, and the data management means place a request with the server for the non-obtained game data so that the non-obtained game data can be stored in the storage means. Thus, new game data can be added to the typing game apparatus as needed, thereby providing the typing game with a sense of constant freshness such that the interest of the player is maintained.

In the typing game apparatus according to the present invention, the music data are constituted by musical accompaniment data recorded in which a musical accompaniment performed by musical instruments is recorded, and voice data which are sung in synchronization with the musical accompaniment. The image data are data recorded with images corresponding to the music data, and include lyrics data corresponding to the music data. Thus the player can play the typing game while enjoying music based on songs that are broadcast on television, radio, and the like. As a result, the typing game can be played with a greater sense of affinity.

The gaming system according to the present invention comprises the typing game apparatus described above, and a server comprising: a storage unit storing a plurality of the game data comprising the image data including the character string, music data, and validity period data indicating the validity period of the image data and music data; management data creation means for creating management data for the game data existing in the storage unit; and server communication means for bidirectional communication with the aforementioned communication means.

Thus management of game data having a validity period can be performed easily and rigorously on a distribution side such as a game company for distributing the game data having a validity period, and an arcade side on which the typing game apparatus is disposed.

What is claimed is:

1. A typing game apparatus comprising:
a display apparatus for displaying a character string to be inputted during a typing game and images;
an input apparatus for inputting said character string;
a sound producing apparatus for producing music data;
a time measuring apparatus for measuring time;
a storage apparatus for storing game data comprising image data including said character string, said music data, and validity period data indicating a validity period of said image data and said music data;
a determination unit for determining the expiration of said validity period of said game data on the basis of said validity period data and said time measuring apparatus; and
a data management unit for deleting said game data from said storage apparatus when said determination unit determines that said validity period of said game data has expired.

2. The typing game apparatus according to claim 1,
wherein said typing game apparatus further comprises a communication apparatus for receiving data from a server comprising a storage unit storing a plurality of said game data and a management data creation unit for creating management data for said game data existing in said storage unit,
wherein said determination unit determines the presence of non-obtained game data which do not exist in said storage apparatus by comparing said management data received by said communication apparatus with the storage content of said storage apparatus, and
wherein said data management unit places a request with said server for said non-obtained game data, and stores said non-obtained game data in said storage apparatus.

3. The typing game apparatus according to claim 1,
wherein said music data are created by music playing data recorded with a music playing performed by musical instruments, and voice data which are sung in synchronization with said music playing, and
said image data are data recorded with images corresponding to said music data, and include lyrics data corresponding to said music data.

4. The typing game apparatus according to claim 1, wherein said time measuring apparatus is a clock having a function for automatically correcting time errors.

5. The typing game apparatus according to claim 1, wherein said determination unit determines the expiration of said validity period of said game data when power is supplied to said typing game apparatus.

6. The typing game apparatus according to claim 1, wherein said input apparatus is a keyboard, and an LED unit is disposed in the interior of each key of said keyboard for illuminating said key in a first color when an input operation performed on said key is correct, and illuminating said key in a second color when said input operation performed on said key is incorrect.

7. The typing game apparatus according to claim 1, wherein said display apparatus is constituted by a first display unit for displaying said character string to be inputted during said typing game, and a second display unit for displaying said images.

8. A typing game apparatus comprising:
a display apparatus for displaying a character string to be inputted during a typing game and images;
an input apparatus for inputting said character string;
a sound producing apparatus for producing music data;
a time measuring apparatus for measuring time;
a storage apparatus for storing game data comprising image data including said character string, said music data, and validity period data indicating a validity period of said image data and said music data;
a determination unit for determining whether or not a time period up to the expiration of said validity period of said game data is within a reference time period on the basis of said validity period data and said time measuring apparatus; and
a notification apparatus for providing notification that game data determined by said determination unit to be within said reference time period are within said reference time period.

9. A gaming system comprising:
the typing game apparatus according to claim 1; and
a server having:
a server storage unit for storing a plurality of said game data comprising image data including said character string, music data, and said validity period data indicating said validity period of said image data and said music data;
a server management data creation unit for creating management data for said game data existing in said server storage unit; and
a server communication apparatus for bidirectional communication with said communication apparatus.

10. The gaming system according to claim 9, wherein said server further comprises a server time measuring apparatus utilized during the creation of a data list of said game data that can be distributed to said typing game apparatus from said server.

11. The gaming system according to claim 10, wherein said server time measuring apparatus is a clock having a function for automatically correcting time errors.

12. A gaming system comprising:
the typing game apparatus according to claim 8; and
a server having:
a server storage unit for storing a plurality of said game data comprising image data including said character string, music data, and said validity period data indicating said validity period of said image data and said music data;
a server management data creation unit for creating management data for said game data existing in said server storage unit; and
a server communication apparatus for bidirectional communication with said communication apparatus.
